(19) United States
(12) Patent Application Publication
(10) Pub. No.: US 2012/0213692 A1
(43) Pub. Date: Aug. 23, 2012

(54) DISTILLATION PROCESS FOR SEPARATING CHLORINE FROM GAS STREAMS COMPRISING OXYGEN AND CHLORINE

(75) Inventors: Hans-Jürgen Pallasch, Kallstadt (DE); Heiner Schelling, Kirchheim (DE); Peter Van den Abeel, Brasschaat (BE); Till Einig, Weinheim (DE)

(73) Assignee: BASE SE, Ludwigshafen (DE)

(21) Appl. No.: 13/363,757

(22) Filed: Feb. 1, 2012

Related U.S. Application Data
(60) Provisional application No. 61/444,171, filed on Feb. 18, 2011.

(51) Int. Cl. C01B 7/04; F25J 3/08

(52) U.S. Cl. 423/502; 62/617

(57) ABSTRACT

The invention relates to a process for separating chlorine from a gas stream I comprising oxygen and chlorine, in which the gas stream I is fed into a lower part of a column K1 and a separately provided liquid, hydrogen chloride stream II is fed into an upper part of the same column and the ascending gaseous stream I is brought into contact with the descending liquid stream II, with chlorine condensing out from the stream I and hydrogen chloride vaporizing from the stream II to give an essentially chlorine-free gas stream III comprising hydrogen chloride and oxygen and a liquid stream IV comprising chlorine.

The invention relates to a distillation process for separating chlorine from a gas stream comprising oxygen and chlorine and also a process for preparing chlorine from hydrogen chloride which comprises this distillation process.

In many chemical processes in which chlorine or downstream products of chlorine, e.g. phosgene, are used, hydrogen chloride is obtained as by-product. Examples are the preparation of isocyanates, of polycarbonates or the chlorination of aromatics. The hydrogen chloride obtained as by-product can be converted back into chlorine by electrolysis or by oxidation by means of oxygen. The chlorine produced in this way can then be reused.

In the process of catalytic oxidation of hydrogen chloride developed by Deacon in 1868, hydrogen chloride is oxidized to chlorine by means of oxygen in an exothermic equilibrium reaction. Conversion of hydrogen chloride into chlorine enables chlorine production to be decoupled from sodium hydroxide production by chloralkali electrolysis. Such decoupling is attractive since, worldwide, the demand for chlorine is growing more strongly than the demand for sodium hydroxide. In addition, hydrogen chloride is obtained in large quantities as co-product, for example in phosgenation reactions, for instance in isocyanate production. The hydrogen chloride formed in isocyanate production is predominantly used in the oxychlorination of ethylene to 1,2-dichloroethane which is processed further to give vinyl chloride and finally to give PVC.

It is common to all known processes involving oxidation of hydrogen chloride by means of oxygen that a gas mixture comprising not only the target product chlorine but also water, unreacted hydrogen chloride and oxygen and also possibly further secondary constituents such as carbon dioxide and inert gases is obtained in the reaction. To obtain pure chlorine, the product gas mixture is cooled after the reaction to such an extent that the water of reaction and hydrogen chloride condense out in the form of concentrated hydrochloric acid. The hydrochloric acid formed is separated off and the remaining gas mixture is freed of residual water by scrubbing with concentrated sulfuric acid or by drying by means of zeolites. The now water-free gas mixture is subsequently compressed and cooled so that chlorine condenses out but oxygen and other low-boiling gas constituents remain in the gas phase. The liquefied chlorine is separated off and optionally purified further.

EP-A 0 765 838 discloses a process for working up the reaction gas composed of chlorine, hydrogen chloride, oxygen and water vapor which is formed in the oxidation of hydrogen chloride, in which the reaction gas leaving the oxidation reactor is cooled to such an extent that water of reaction and hydrogen chloride condense out in the form of concentrated hydrochloric acid, the concentrated hydrochloric acid is separated off from the reaction gas and discharged while the remaining reaction gas which has been essentially freed of water and part of the hydrogen chloride is dried, the dried reaction gas composed of chlorine, oxygen and hydrogen chloride is compressed to 1-30 bar and the compressed reaction gas is cooled and in the process mostly liquefied, with components of the reaction gas which do not condense out being at least partly recirculated to the oxidation reactor.

To separate off chlorine, the dried and compressed reaction gas mixture is liquefied so as to leave a residual proportion of about 10-20% in a chlorine recuperator configured as expansion cooler. The liquid main chlorine stream separated off in the chlorine recuperator is subsequently purified further in a distillation column in which the chlorine is freed of residual dissolved hydrogen chloride, oxygen and inert gases. The gas taken off at the top of the distillation column, which consists essentially of hydrogen chloride, chlorine, oxygen and inert gases, is recirculated to the compression stage. The gas components which are not condensed out in the chlorine recuperator, including the residual proportion of chlorine, are partly liquefied at a significantly lower temperature in an after-cooling stage. The remaining offgas composed of unreacted hydrogen chloride, oxygen and inert gases is recycled to the oxidation reactor. A substream of the recycled gas is separated off as purge gas stream and discharged from the process in order to prevent accumulation of impurities.

A disadvantage of the processes of the prior art in which chlorine is separated off from the chlorine-comprising product gas stream from the oxidation of hydrogen chloride exclusively by condensation is that very low temperatures or high pressures are required to substantially free the product gas stream of chlorine. In addition, the tailgas stream comprising the uncondensable gas constituents still comprises considerable amounts of inert gases including carbon dioxide. These would accumulate to unacceptably high values in the recirculation of the oxygen-comprising tailgas stream to the hydrogen chloride oxidation reactor, so that a purge gas stream has to be separated off from this tailgas stream before recirculation to the oxidation of hydrogen chloride and discharged from the process. However, this purge gas stream still comprises appreciable amounts of chlorine since chlorine is only incompletely separated off by condensation. Thus, appreciable amounts of chlorine are lost with the purge gas stream.

WO 07134716 and WO 07085476 describe the advantageous effect of the presence of HCl in the removal of chlorine. In the process described in WO 07085476, the condensation stage for water and HCl is operated in such a way that an advantageous amount of hydrogen chloride goes with the process gas via the drying stage into the compressor and the subsequent removal of chlorine. In the process described in WO 07134716, part of the gaseous hydrogen chloride is taken from the feed stream to the process and, bypassing the other process stages, fed directly to the chlorine removal.

WO 07085476 describes a process for preparing chlorine from hydrogen chloride, which comprises the steps
a) introduction of a stream a1 comprising hydrogen chloride and a stream a2 comprising oxygen into an oxidation zone and catalytic oxidation of hydrogen chloride to chlorine, giving a product gas stream a3 comprising chlorine, water, oxygen, carbon dioxide and inert gases;
b) contacting of the product gas stream a3 with aqueous hydrochloric acid I in a phase contact apparatus and partial separation of water and of hydrogen chloride from the stream a3, leaving a gas stream b comprising hydrogen chloride, chlorine, water, oxygen, carbon dioxide and possibly inert gases, where at least 5% of the hydrogen chloride comprised in the stream a3 remains in the gas stream b;
c) drying of the gas stream b to leave an essentially water-free gas stream c comprising hydrogen chloride, chlorine, oxygen, carbon dioxide and possibly inert gases;
d) partial liquefaction of the gas stream c by compression and cooling to give an at least partially liquefied stream d;
e) gas/liquid separation of the stream d into a gas stream e1 comprising chlorine, oxygen, carbon dioxide, hydrogen chloride and possibly inert gases and a liquid stream e2 comprising hydrogen chloride, chlorine, oxygen and carbon dioxide and optionally recirculation of at least part of the gas stream e1 to step a);

f) separation of the liquid stream e2 into a chlorine stream f1 and a stream f2 consisting essentially of hydrogen chloride, oxygen and carbon dioxide by distillation in a column, where part of the hydrogen chloride condenses at the top of the column and flows back as runback into the column, as a result of which a stream f2 having a chlorine content of <1% by weight is obtained.

The dried gas stream c, which consists essentially of chlorine and oxygen and additionally comprises hydrogen chloride and inert gases (carbon dioxide, nitrogen), is compressed in a number of stages to about 10-40 bar in step d). The compressed gas is cooled to temperatures of from about −10 to −40° C.

The compressed and partially liquefied, two-phase mixture is finally fractionated in a mass transfer apparatus. The unliquefied gas stream is here contacted in countercurrent or in cocurrent with the liquid which consists essentially of chlorine and dissolved carbon dioxide, hydrogen chloride and oxygen. As a result, the unliquefied gases accumulate in the liquid chlorine until thermodynamic equilibrium is reached, so that inert gases, in particular carbon dioxide, can be separated off via the offgas from the subsequent chlorine distillation.

The liquefied chlorine having a chlorine content of >85% by weight is subjected to a distillation at about 10-40 bar. The temperature at the bottom is from about 30 to 110° C., and the temperature at the top is, depending on the hydrogen chloride content of the liquefied chlorine, in the range from about −5 to −8° C. and from about −25 to −30° C. At the top of the column, hydrogen chloride is condensed and allowed to flow back into the column. As a result of the reflux of HCl, virtually complete removal of chlorine is achieved, thus minimizing the loss of chlorine. The chlorine which is taken off at the bottom of the column has a purity of >99.5% by weight.

An important disadvantage of the abovementioned processes is the comparatively high energy consumption for liquefaction of the chlorine gas stream by means of either very high operating pressures (from 15 to 40 bar) or alternatively, at low operating pressures, very low condensation temperatures (from −35 to −80° C.).

It is an object of the invention to provide an improved process for separating chlorine from a gas stream comprising at least chlorine and oxygen. In particular, it is an object of the invention to provide a process of this type for separating chlorine from a gas stream comprising chlorine, hydrogen chloride, oxygen, carbon dioxide and possibly further inert gases in a process for the catalytic oxidation of hydrogen chloride.

This object is achieved by a process for separating chlorine from a gas stream I comprising oxygen and chlorine, in which the gas stream is fed into a lower part of a column K1 and a separately provided liquid, hydrogen chloride stream II is fed into an upper part of the same column and the ascending gaseous stream I is brought into contact with the descending liquid stream II, with gaseous chlorine condensing out from the stream I and liquid hydrogen chloride vaporizing from the stream II to give an essentially chlorine-free gas stream III comprising hydrogen chloride and oxygen and a liquid stream IV comprising chlorine.

A column in the sense of the present invention is a multistage heat transfer and mass transfer apparatus in which heat transfer and mass transfer between a liquid phase and a gaseous phase occurs.

In general, the essentially chlorine-free gas stream III is obtained as an overhead offtake stream and the liquid stream IV is obtained as a bottom offtake stream.

The crude gas stream I is fed into a lower part of a column K1 and the separately provided liquid hydrogen chloride stream II is fed into an upper part of the same column. The crude gas stream I is thus fed into the column K1 below the point at which the separately prepared liquid hydrogen chloride stream II is fed in. In general, the liquid hydrogen chloride stream is introduced into the upper half of the column and the gas stream to be fractionated is introduced in the lower half of the column. The liquid hydrogen chloride stream II is preferably introduced at the top of the column.

In general, the column K1 is operated at a pressure of from 1 to 30 bar, preferably from 3 to 15 bar. The temperature at the bottom of the column is from −50 to +90° C., preferably from −40 to +60° C., and the temperature at the top of the column is from −80 to +10° C., preferably from −60 to −10° C.

Due to the use of liquid hydrogen chloride in the isolation of chlorine in the Deacon process, the heat required for vaporization of hydrogen chloride is provided by the process gas stream fed into the isolation of chlorine and the heat to be removed in the condensation of chlorine is thus simultaneously withdrawn from this process gas stream. According to the invention, this is effected by direct energy exchange by contacting of the two process streams in columns. In addition, indirect energy exchange can be effected via heat exchange surfaces in heat exchangers.

The hydrogen chloride stream is provided separately, i.e. it does not occur as runback stream in the distillation itself. Rather, it is provided from an external source and fed into the distillation column at a suitable point in addition to the gas mixture to be fractionated.

The contacting of the process streams advantageously takes place in a countercurrent column having from 2 to 20 theoretical plates. As internals, it is possible to use random packing elements, structured packings or trays. In general, the column is operated at a pressure of from 1 to 30 bar. The pressure in the column is preferably above the operating pressure of the hydrogen chloride oxidation reactor. For example, the pressure in the column is from 0.5 to 15 bar above the operating pressure of the hydrogen chloride oxidation reactor.

The liquid hydrogen chloride stream can be produced simply by condensation at from 10 to 25 bar by means of a conventional refrigeration plant at condensation temperatures of from −10 to −40° C. This is advantageously integrated with, for example, an isocyanate or polycarbonate plant since the low proportion of inert gas of less than 10% makes simple condensation possible. The condensation is particularly advantageously integrated into a purification of hydrogen chloride by distillation, since in this case hydrogen chloride is obtained in relatively high purity in the vicinity of the dew point. Depending on the conditions and the composition of the dried crude gas stream in the removal of chlorine, it is not necessary to liquefy the entire amount of HCl used in the HCl oxidation.

In general, the hydrogen chloride used in the process of the invention is hydrogen chloride obtained as discharge stream obtained in a process in which hydrogen chloride is formed as co-product. Such processes are, for example,
(1) the preparation of isocyanate from phosgene and amines,
(2) acid chloride production,
(3) polycarbonate production,
(4) the preparation of vinyl chloride from ethylene dichloride,
(5) chlorination of aromatics.

The use of liquid hydrogen chloride provides the “cold” required for condensation in the low-temperature range (temperature <20° C.) in a simple way and also ensures an increase in the HCl concentration in the case of direct introduction into the chlorine removal column as a result of which the content of chlorine in the oxygen-comprising recycle stream recirculated to the hydrogen chloride oxidation reactor can be kept low. The HCl dissolved in the chlorine during the condensation of chlorine can be removed by distillation as overhead product in a column or as liquid side offtake stream in the enrichment section of the column in a subsequent chlorine purification.

In a preferred embodiment of the process of the invention, the liquid stream IV is fed into a lower part of a second column K2 and a further separately provided liquid hydrogen chloride stream V is fed into an upper part of this second column and an essentially chlorine-free gas stream VI comprising hydrogen chloride with oxygen and a liquid stream VII consisting essentially of chlorine are obtained.

The gas stream VI is generally obtained as overhead offtake stream and the liquid stream VII is generally obtained as bottom offtake stream.

In general, the column K2 is operated at a pressure of from 1 to 30 bar, preferably from 3 to 15 bar. The temperature at the bottom of the column is from −50 to +90° C., preferably from −40 to +60° C., and the temperature at the top of the column is from −80 to +10° C., preferably from −60 to −10° C.

In one variant, the stream III from the column K1 and optionally the stream VI from the column K2 are used for precooling the gas stream I comprising oxygen and chlorine in a heat exchanger.

In a further preferred embodiment, the liquid stream IV is fed into a second column K2 and separated into a gas stream VI comprising hydrogen chloride and possibly traces of further gases such as CO₂, N₂ and O₂ and a liquid stream VII consisting essentially of chlorine. The overhead offtake stream VI is fed into the lower part of the column K1, with the column K2 being operated at a higher pressure than the column K1.

In general, the gas stream VI is obtained as overhead offtake stream and the liquid stream VII is obtained as bottom offtake stream.

In general, the column K1 is operated at a pressure of from 1 to 30 bar, preferably from 3 to 15 bar. The temperature at the bottom of the column is from −50 to +90° C., preferably from −40 to +60° C., and the temperature at the top of the column is from −80 to +10° C., preferably from −60 to −10° C.

Here too, the stream III from the column K1 can, in one variant, be used for indirect cooling of the gas stream I comprising oxygen and chlorine in a heat exchanger.

In particular embodiments of the process of the invention, the gas stream I comprising oxygen and chlorine is precooled indirectly by means of liquid hydrogen chloride in a heat exchanger.

The gas stream I comprising oxygen and chlorine can comprise carbon dioxide and possibly further inert gases such as nitrogen and noble gases.

In one variant of the above-described embodiment, the columns K1 and K2 are combined to form a single column K1. This column K1 has an enrichment section and a stripping section, with the gas stream I being fed in in the middle of the column K1 between enrichment section and stripping section and the separately provided liquid hydrogen chloride stream II is fed in at the top of the column, and the ascending gaseous stream I is brought into contact with the descending liquid stream II in the enrichment section of the column. This gives an essentially chlorine-free gas stream III comprising hydrogen chloride and oxygen as overhead offtake stream and a liquid stream IV consisting essentially of chlorine as bottom offtake stream.

The invention further provides a process for preparing chlorine from hydrogen chloride, which comprises the steps:
a) introduction of a stream a1 comprising hydrogen chloride and a stream a2 comprising oxygen into an oxidation zone and catalytic oxidation of hydrogen chloride to chlorine, giving a product gas stream a3 comprising chlorine, water, oxygen, carbon dioxide and inert gases;
b) contacting of the product gas stream a3 with aqueous hydrochloric acid I in a phase contact apparatus and at least partial separation of water and of hydrogen chloride from the stream a3, leaving a gas stream b comprising hydrogen chloride, chlorine, water, oxygen, carbon dioxide and possibly inert gases;
c) drying of the gas stream b to leave an essentially water-free gas stream c comprising hydrogen chloride, chlorine, oxygen, carbon dioxide and possibly inert gases;
d) optionally compression and cooling of the gas stream c;
e) introduction of the gaseous stream c into a lower part of a column K1 and introduction of a separately provided liquid hydrogen chloride stream e into an upper part of the same column K1 and contacting of the ascending gaseous stream c with the descending liquid stream e, with gaseous chlorine condensing out from stream c and liquid hydrogen chloride vaporizing from the stream e to give an essentially chlorine-free gas stream e1 comprising hydrogen chloride, oxygen, carbon dioxide and possibly inert gases and a liquid stream e2 comprising chlorine;
f) recirculation of at least part of the essentially chlorine-free gas stream e1 comprising hydrogen chloride, oxygen, carbon dioxide and possibly inert gases to the oxidation step a).

In the oxidation step a), a stream a1 comprising hydrogen chloride is fed together with an oxygen-comprising stream a2 into an oxidation zone and catalytically oxidized.

According to the invention, at least part of the hydrogen chloride introduced into step a) originates from the separate hydrogen chloride stream e fed to the chlorine removal step e).

In the catalytic process, hydrogen chloride is oxidized to chlorine by means of oxygen in an exothermic equilibrium reaction, forming water vapor. Usual reaction temperatures are in the range from 150 to 500° C., and usual reaction pressures are in the range from 1 to 25 bar. Furthermore, it is advantageous to use oxygen in superstoichiometric amounts. For example, a two- to four-fold oxygen excess is customary. Since no decreases in selectivity have to be feared, it can be economically advantageous to work at relatively high pressures and accordingly at residence times longer than those at atmospheric pressure.

Suitable catalysts comprise, for example, ruthenium oxide, ruthenium chloride or other ruthenium compounds on silicon dioxide, aluminum oxide, titanium dioxide or zirconium dioxide as support. Suitable catalysts can be obtained, for example, by application of ruthenium chloride to the support and subsequent drying or drying and calcination. Suitable catalysts can also comprise, in addition to or in place of a ruthenium compound, compounds of other noble metals, for example gold, palladium, platinum, osmium, iridium, silver, copper or rhenium. Suitable catalysts can also comprise chromium(III) oxide.

Customary reaction apparatuses in which the catalytic oxidation of hydrogen chloride is carried out are fixed-bed or fluidized-bed reactors. The oxidation of hydrogen chloride can be carried out in a plurality of stages.

The catalytic oxidation of hydrogen chloride can be carried out adiabatically or preferably isothermally or approximately isothermally, batchwise, preferably continuously, as a fluidized-bed or fixed-bed process. It is preferably carried out in a fluidized-bed reactor at a temperature of from 320 to 450° C. and a pressure of from 2 to 10 bar.

When the oxidation is carried out in a fixed bed, it is also possible to use a plurality of, i.e. from 2 to 10, preferably from 2 to 6, particularly preferably from 2 to 5, in particular 2 or 3, reactors connected in series with additional intermediate cooling. The oxygen can either all be introduced together with the hydrogen chloride upstream of the first reactor or the introduction of the oxygen can be distributed over the various reactors. This arrangement of individual reactors in series can also be combined in one apparatus.

Any shapes are suitable as shaped catalyst bodies, with preference being given to pellets, rings, cylinders, stars, wagon wheels or spheres, particularly preferably rings, cylinders or star extrudates.

Suitable heterogeneous catalysts are, in particular, ruthenium compounds or copper compounds on support materials; the catalysts can also be doped and preference is given to optionally doped ruthenium catalysts. Suitable support materials are, for example, silicon dioxide, graphite, titanium dioxide having a rutile or anatase structure, zirconium dioxide, aluminum oxide or mixtures thereof, preferably titanium dioxide, zirconium dioxide, aluminum oxide or mixtures thereof, particularly preferably gamma- or alpha-aluminum oxide or mixtures thereof.

The supported copper or ruthenium catalyst can, for example, be obtained by impregnating the support material with aqueous solutions of CuCl₂ or RuCl₃ and optionally a promoter for doping, preferably in the form of their chlorides. Shaping of the catalyst can be carried out after or preferably before impregnation of the support material.

Suitable promoters for doping are alkali metals such as lithium, sodium, potassium, rubidium and cesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

Preferred promoters are calcium, silver and nickel. Particular preference is given to the combination of ruthenium with silver and calcium and of ruthenium with nickel as promoter.

The support material can be dried and optionally calcined at temperatures of from 100 to 500° C., preferably from 100 to 400° C., for example under a nitrogen, argon or air atmosphere, after impregnation and doping. The support material is preferably firstly dried at from 100 to 200° C. and subsequently calcined at from 200 to 400° C.

The volume ratio of hydrogen chloride to oxygen at the reactor inlet is generally in the range from 1:1 to 20:1, preferably from 2:1 to 8:1, particularly preferably from 2:1 to 5:1.

In a step b), the product gas stream a3 is brought into contact with aqueous hydrochloric acid I in a phase contact apparatus and water and hydrogen chloride are partly separated off from the stream a3, leaving a gas stream b comprising hydrogen chloride, chlorine, water, oxygen, carbon dioxide and possibly inert gases. In this step, which can also be referred to as quench and absorption step, the product gas stream a3 is cooled and water and hydrogen chloride are at least partly separated off as aqueous hydrochloric acid from the product gas stream a3. The hot product gas stream a3 is cooled by contacting with dilute hydrochloric acid I as quenching medium in a suitable phase contact apparatus, for example a packed or tray column, a jet scrubber or a spray tower, resulting in part of the hydrogen chloride being absorbed in the quenching medium. The quenching and absorption medium is hydrochloric acid which is not saturated with hydrogen chloride.

In a preferred embodiment of the process of the invention, the phase contact apparatus has two stages, with the first stage being a pipe quench apparatus and the second stage being a falling film heat exchanger. This configuration of the phase contact apparatus as pipe quench has the advantage that no expensive corrosion-resistant material such as tantalum has to be used since the parts of the quench apparatus which are in contact with the product only come into contact with cooled hydrochloric acid. It is therefore possible to use inexpensive materials such as graphite.

In general, the phase contact apparatus is operated with circulating hydrochloric acid I. In a preferred embodiment, at least part of the aqueous hydrochloric acid circulating in the phase contact apparatus, for example from 1 to 20%, is taken from the phase contact apparatus and subsequently distilled, with gaseous hydrogen chloride and an aqueous hydrochloric acid II depleted in hydrogen chloride being obtained and the hydrogen chloride being recirculated to step a) and at least part of the aqueous hydrochloric acid II being recirculated to the phase contact apparatus.

The hydrochloric acid distillation can be carried out in a plurality of stages. For example, a pressure distillation can firstly be carried out, with hydrogen chloride being obtained at the top of the column and azeotropically boiling, dilute hydrochloric acid having a hydrogen chloride content in the range from, for example, 15 to 22% by weight being obtained at the bottom. The bottom offtake stream from the pressure distillation column is subsequently subjected to a vacuum distillation, with water being obtained at the top of the vacuum distillation column and a more highly concentrated azeotropically boiling hydrochloric acid having a hydrogen chloride content of, for example, from 20 to 28% by weight being obtained at the bottom of the column. The hydrochloric acid obtained during pressure distillation and vacuum distillation can in each case be partly or completely recirculated to the phase contact apparatus and combined with the circulating liquid.

The gas stream b leaving the phase contact apparatus comprises chlorine, hydrogen chloride, water, oxygen, carbon dioxide and generally also inert gases. This can be freed of traces of moisture by contacting with suitable desiccants in a subsequently drying stage c). Suitable desiccants are, for example, concentrated sulfuric acid, molecular sieves and hygroscopic adsorbents. This gives an essentially water-free gas stream c comprising chlorine, oxygen, carbon dioxide and possibly inert gases.

The gas stream b is generally cooled before the drying step c).

In a step d), the gas stream c is optionally compressed and optionally cooled to give a compressed or cooled or compressed and cooled gaseous stream c.

In one embodiment of the process of the invention, the gas stream c is cooled by means of a liquid hydrogen chloride stream in a heat exchanger. The cooled stream generally has a pressure in the range from 2 to 25 bar and a temperature in the range from −50 to 0° C.

In a step e), the stream c is fed into a lower part of a column K1 and a separately provided liquid hydrogen chloride stream e is fed into an upper part of the same column K1 and the ascending gaseous stream c is brought into contact with the descending liquid stream e, resulting in gaseous chlorine condensing out from the stream c and liquid hydrogen chloride vaporizing from the stream e to give an essentially chlorine-free gas stream e1 comprising hydrogen chloride, oxygen, carbon dioxide and possibly inert gases and a liquid stream e2 comprising chlorine.

In general, the essentially chlorine-free gas stream e1 is obtained as overhead offtake stream and the liquid, chlorine-comprising stream e2 is obtained as bottom offtake stream.

In a preferred embodiment, the liquid stream e2 is fed into a lower part of a second column K2 and a further separately provided liquid hydrogen chloride stream e3 is fed into an upper part of the same column and an essentially chlorine-free gas stream e4 comprising hydrogen chloride and oxygen is obtained as overhead offtake stream and a liquid stream e5 consisting essentially of chlorine is obtained as bottom offtake stream.

In general, the essentially chlorine-free gas stream e4 is obtained as overhead offtake stream and the liquid stream e5 consisting essentially of chlorine is obtained as bottom offtake stream.

In one variant, the overhead offtake stream e1 from the column K1 and optionally the overhead offtake stream e4 from the column K2 is used for precooling the gas stream d comprising oxygen and chlorine in a heat exchanger.

In a further preferred embodiment, the liquid stream e2 is fed into a second column K2 and separated into a gaseous overhead offtake stream e4 comprising hydrogen chloride and oxygen and a liquid bottom offtake stream e5 consisting essentially of chlorine and the overhead offtake stream e4 is fed into the lower part of the column K1, with the column K2 being operated at a higher pressure than the column K1.

In general, the stream e4 is obtained as overhead offtake stream and the stream e5 is obtained as bottom offtake stream.

In one variant, the gas stream c comprising oxygen and chlorine is precooled by means of liquid hydrogen chloride in a heat exchanger.

The overhead offtake stream e1 comprising hydrogen chloride and optionally the overhead offtake stream e4 comprising hydrogen chloride are fed at least partly into the oxidation step a) of the process.

A substream is preferably separated off from the hydrogen chloride-comprising overhead offtake stream or streams to discharge carbon dioxide and possibly further inert gases (purge gas stream) before the streams are fed into the oxidation step.

The purge gas stream which has been separated off is subjected to scrubbing with water or aqueous hydrochloric acid to separate off hydrogen chloride.

In a further optional step, the purge gas stream is brought into contact with a solution comprising sodium hydrogencarbonate and sodium hydrogensulfite and having a pH of from 7 to 9 in order to separate off very small amounts of chlorine.

The purge gas stream is preferably contacted in a scrubbing column with a pump circulation stream comprising sodium hydrogencarbonate and sodium sulfite which has a pH of about 7.0-9.0. The pump circulation stream is introduced at the top of a scrubbing column. Essentially the following (equilibrium) reactions occur here:

CO₂+H₂O+NaOH⇄NaHCO₃+H₂O (1)

Cl₂+NaHCO₃⇄NaCl+HOCl+CO₂ (2)

HOCl+Na₂SO₃→NaCl+NaHSO₄ (3)

Part of the bottom offtake stream comprising NaCl, NaHSO₄/Na₂SO₄, NaHSO₃/Na₂SO₃ and NaHCO₃ is discharged. The pump circulation stream is supplemented with fresh alkaline aqueous sodium sulfite solution. Since only little carbon dioxide is bound by means of this mode of operation, a comparatively low NaOH consumption in the scrubbing step results.

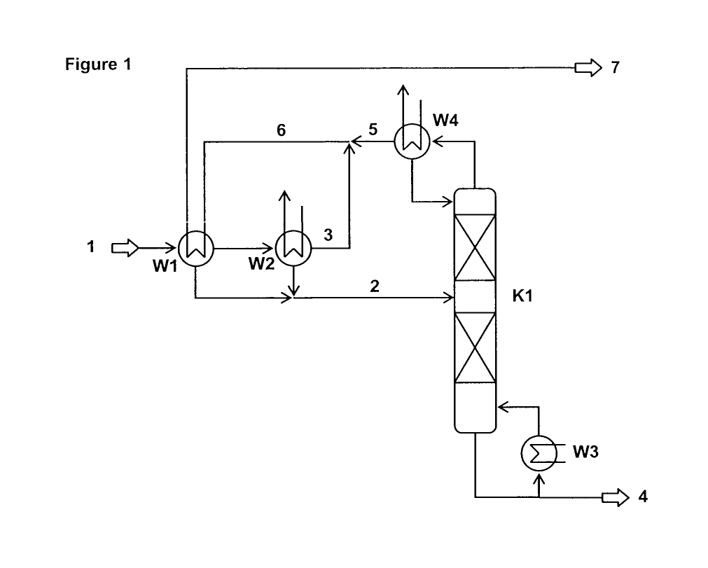

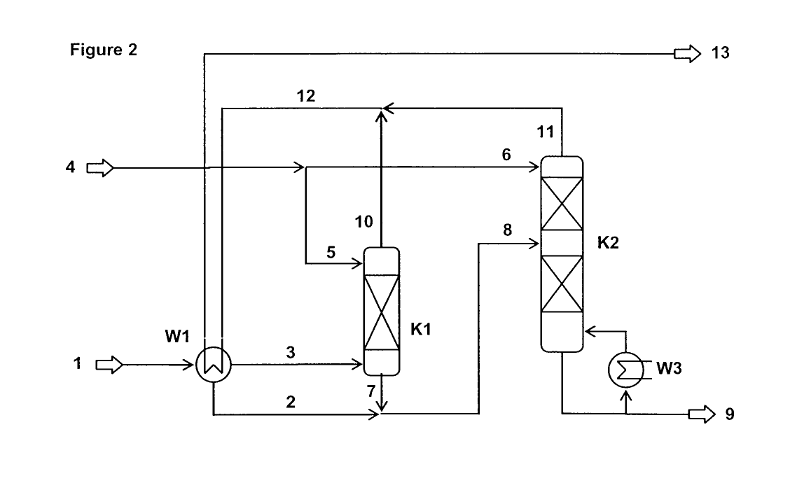

The invention is illustrated with the aid of FIGS. 1 to 4. FIG. 1 shows an embodiment according to the prior art. Specific embodiments of the process of the invention are shown in FIGS. 2 to 4.

FIG. 1 shows, by way of example, a conventional separation of chlorine from a crude gas stream comprising oxygen, chlorine, hydrogen chloride and inert gases. A heat integration measure is likewise shown by way of example.

The dried gas stream 1 comprising predominantly chlorine and oxygen and also further gases such as HCl, CO₂ and nitrogen, as is obtained, for example, on the pressure side of a compressor, is cooled further in the heat exchanger W1. The condensation takes place predominantly in the heat exchanger W2 operated using conventional cooling media. The condensed crude chlorine 2 is fed, for the purposes of purification, to a distillation column K1 with W3 as vaporizer and W4 as reflux condenser. An in-specification liquid chlorine is obtained as stream 4 at the bottom of the column. The lower boilers 5 separated off, essentially hydrogen chloride, oxygen, carbon dioxide and nitrogen, leave the column in gaseous form at the top or via the condenser W4. They are combined with the uncondensed gas 3 from W2 and conveyed through the heat exchanger W1 to precool the crude gas stream 1. The warmed gas stream 7 comprises HCl, oxygen, carbon dioxide, chlorine and nitrogen and is predominantly returned to the hydrogen chloride oxidation.

FIG. 2 shows, by way of example, the condensation of chlorine from a gas mixture comprising chlorine, hydrogen chloride, oxygen, carbon dioxide and further inert gases according to the present invention. A heat integration measure is likewise shown by way of example.

The dried crude gas stream 1 comprising predominantly chlorine and oxygen and also further gases such as HCl, CO₂ and nitrogen, as is obtained, for example, on the pressure side of a compressor, is cooled further in the heat exchanger W1.

The cooled crude gas stream 3, which can also consist of two phases, is fed into the bottom of a countercurrent column K1. At the top of the column K1, liquid hydrogen chloride 5 is introduced as runback. The hydrogen chloride is vaporized by means of the intensive heat transfer and mass transfer in the column and the chlorine is condensed out from the gas stream. The gaseous overhead offtake stream 10 from the column K1 comprises only small amounts of chlorine. The liquid bottom offtake stream 7 comprises predominantly chlorine. This condensed crude chlorine 7 is, together with any liquid substream 2 of the crude gas stream, fed to a distillation column K2 for further purification. In-specification liquid chlorine 9 is obtained at the bottom of the column. The column K2 has no overhead condenser, but instead liquid hydrogen chloride 6 is introduced as runback at the top of the column as in the case of column K1. As in the case of column K1, the hydrogen chloride is also vaporized by means of the intensive heat transfer and mass transfer in the column K2 and a relatively high chlorine concentration in the gaseous overhead offtake stream is prevented. The low boilers present in the feed to the column K2, essentially oxygen, hydrogen chloride, carbon dioxide and inert gases, leave the column in gaseous form at the top as stream 11. The gaseous overhead offtake streams 10 and 11 are combined to form stream 12 and passed through the heat exchanger W1 to precool the crude gas stream 1. The warm gas stream 13 is predominantly fed to the hydrogen chloride oxidation.

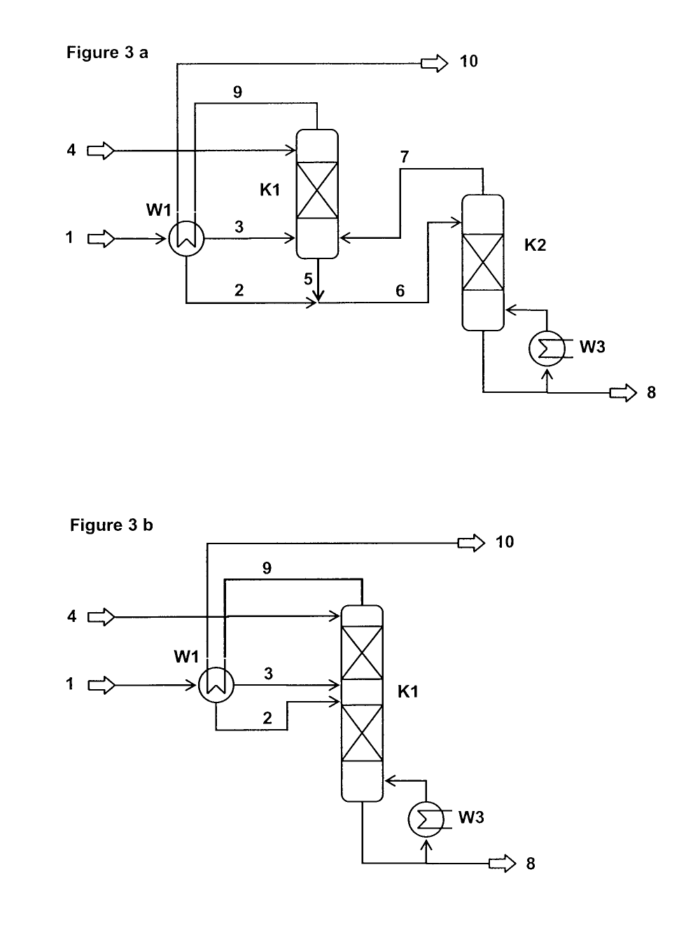

FIG. 3a shows, by way of example, a variant of the condensation of chlorine from a crude gas mixture comprising chlorine, hydrogen chloride, oxygen, carbon dioxide and further inert gases according to the present invention.

The dried crude gas stream 1 comprising predominantly chlorine and oxygen and also further gases such as HCl, CO₂ and nitrogen, as is obtained, for example, on the pressure side of a compressor, is cooled further in the heat exchanger W1.

The cooled crude gas stream 3, which can also consist of two phases, is fed into the bottom of a countercurrent column K1. Liquid hydrogen chloride 4 is introduced as runback at the top of the column K1. The hydrogen chloride is vaporized by means of the intensive heat transfer and mass transfer in the column and the chlorine is condensed out from the gas stream. The liquid bottom offtake stream 5 comprises predominantly chlorine. The condensed crude chlorine is, together with any liquid substream 2 of the crude gas stream, fed as stream 6 to a distillation column K2 for further purification. In-specification liquid chlorine 8 is obtained at the bottom of the column. The low boilers present in the feed to the column K2, essentially oxygen, hydrogen chloride and carbon dioxide and also further inert gases, leave the column in gaseous form at the top as stream 7. This is likewise fed into the bottom of the column K1. This is achieved by the column K2 being operated at a somewhat higher pressure than the column K1. Chlorine still comprised in the overhead offtake stream from the column K2 is thus condensed in the column K1.

No liquid hydrogen chloride is introduced into the column K2. The gaseous overhead offtake stream 9 from the column K1 is predominantly chlorine-free. This is utilized for precooling the crude gas stream in the heat exchanger W1. The stream 10 is predominantly fed to the hydrogen chloride oxidation.

FIG. 3b shows a variant of the embodiment of FIG. 3a, in which the two columns K1 and K2 are operated at the same pressure and have been combined to form one column. This single column thus comprises an enrichment section and a stripping section, with the cooled crude gas stream 3 and a liquid substream 2 of the crude gas stream being introduced in the middle of the column. Liquid hydrogen chloride is introduced as runback at the top of the column K1. Hydrogen chloride is vaporized by means of the intensive heat transfer and mass transfer in the enrichment section of the column which corresponds to the column K1 in FIG. 3a and the chlorine is condensed out from the gas stream. In the stripping section of the column, which corresponds to the column K2 in FIG. 3a, a high degree of purification of the condensed-out chlorine is achieved. The liquid bottom offtake stream comprises essentially pure chlorine. The gaseous overhead offtake stream 9 from the column K1 is predominantly chlorine-free. This is utilized for precooling the crude gas stream in the heat exchanger W1 and fed as stream 10 predominantly to the hydrogen chloride oxidation.

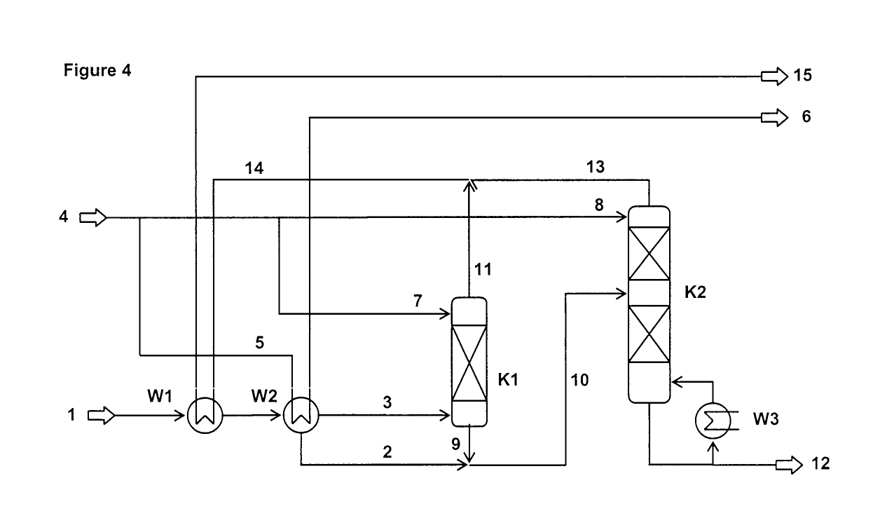

FIG. 4 shows, by way of example, a variant of the process of the invention with additional indirect cooling of the crude gas mixture by means of liquid hydrogen chloride in a heat exchanger.

The dried crude gas stream 1 comprising predominantly chlorine and oxygen and also further gases such as HCl, CO₂ and nitrogen, as is obtained, for example, on the pressure side of a compressor, is cooled further in the heat exchanger W1.

The cooled crude gas stream, which can also consist of two phases, is fed to a second heat exchanger W2 where it is cooled further and largely condensed. The heat removed in W2 effects vaporization of liquid hydrogen chloride on the other side of the heat exchange surface.

The gas stream 3 leaving the heat exchanger W2, which can also consist of two phases, is fed into the bottom of a countercurrent column K1. Liquid hydrogen chloride 7 is introduced as runback at the top of the column K1. The hydrogen chloride is vaporized by means of the intensive heat transfer and mass transfer in the column and further chlorine is condensed out from the crude gas stream. The gaseous overhead offtake stream 11 from the column comprises only small amounts of chlorine. The liquid bottom offtake stream 9 comprises predominantly chlorine and is combined with the optionally liquid substream 2 of crude chlorine from W2. The combined chlorine stream 10 is fed to a distillation column K2 for further purification. In-specification liquid chlorine is obtained as stream 12 at the bottom of the column. The column K2 has no overhead condenser but instead liquid hydrogen chloride 8 is introduced as runback at the top of the column. The low boilers still present in the feed to the column K2, essentially oxygen, hydrogen chloride, carbon dioxide and further inert gases, leave the column as gaseous overhead offtake stream 13. The gaseous overhead offtake streams 11 and 13 are combined and conveyed as stream 14 through the heat exchanger W1 to precool the crude gas stream. The warmed gas stream 15 is predominantly fed to the hydrogen chloride oxidation reactor.

### EXAMPLES

The processes according to FIGS. 1 to 4 were simulated numerically.

Table 1 shows the conditions and composition of the streams in the process as per FIG. 1.

Table 2 shows the conditions and composition of the streams in the process as per FIG. 2.

Table 3a shows the conditions and composition of the streams in the process as per FIG. 3a.

Table 3b shows the conditions and composition of the streams in the process as per FIG. 3b.

Table 4 shows the conditions and composition of the streams in the process as per FIG. 4.

TABLE 1

| | | Stream | Stream | Stream | Stream | Stream | Stream | Stream |
|---|---|---|---|---|---|---|---|---|
| | | No. 1 | No. 2 | No. 3 | No. 4 | No. 5 | No. 6 | No. 7 |
| Mass flows | | | | | | | | |
| N2 | kg/h | 181.7 | 1.1 | 180.6 | 0.0 | 1.1 | 181.7 | 181.7 |
| ARGON | kg/h | 104.8 | 1.0 | 103.8 | 0.0 | 1.0 | 104.8 | 104.8 |
| O2 | kg/h | 1205.3 | 13.4 | 1191.9 | 0.0 | 13.4 | 1205.3 | 1205.3 |
| CO2 | kg/h | 163.1 | 35.7 | 127.4 | 0.0 | 35.7 | 163.1 | 163.1 |
| HCl | kg/h | 345.6 | 141.3 | 204.3 | 0.0 | 141.3 | 345.6 | 345.6 |
| Cl2 | kg/h | 2999.6 | 2749.4 | 250.1 | 2749.4 | 0.0 | 250.2 | 250.2 |
| Total stream | kg/h | 5000.0 | 2941.9 | 2058.1 | 2749.4 | 192.5 | 2250.6 | 2250.6 |
| Temperature | ° C. | 40.0 | −50.0 | −50.0 | 29.8 | −44.1 | −49.6 | 10.0 |
| Pressure | bar | 7.9 | 7.8 | 7.8 | 8.8 | 7.8 | 7.8 | 7.7 |
| State | | gaseous | liquid | gaseous | liquid | gaseous | gaseous | gaseous |
| Proportions | | | | | | | | |
| by mass | | | | | | | | |
| N2 | wt.-% | 3.6% | 0.0% | 8.8% | 0.0% | 0.6% | 8.1% | 8.1% |
| ARGON | wt.-% | 2.1% | 0.0% | 5.0% | 0.0% | 0.5% | 4.7% | 4.7% |
| O2 | wt.-% | 24.1% | 0.5% | 57.9% | 0.0% | 6.9% | 53.6% | 53.6% |
| CO2 | wt.-% | 3.3% | 1.2% | 6.2% | 0.0% | 18.5% | 7.2% | 7.2% |
| HCl | wt.-% | 6.9% | 4.8% | 9.9% | 0.0% | 73.4% | 15.4% | 15.4% |
| Cl2 | wt.-% | 60.0% | 93.5% | 12.2% | 100.0% | 0.0% | 11.1% | 11.1% |

TABLE 2

| | | Stream | Stream | Stream | Stream | Stream | Stream | Stream |
|---|---|---|---|---|---|---|---|---|
| | | No. 1 | No. 2 | No. 3 | No. 4 | No. 5 | No. 6 | No. 7 |
| Mass flows | | | | | | | | |
| N2 | kg/h | 181.7 | 0.1 | 181.6 | 0.0 | 0.0 | 0.0 | 0.4 |
| ARGON | kg/h | 104.8 | 0.1 | 104.8 | 0.0 | 0.0 | 0.0 | 0.4 |
| O2 | kg/h | 1205.3 | 0.8 | 1204.5 | 0.0 | 0.0 | 0.0 | 5.4 |
| CO2 | kg/h | 163.1 | 1.0 | 162.0 | 0.0 | 0.0 | 0.0 | 8.9 |
| HCl | kg/h | 345.6 | 5.3 | 340.3 | 2689.4 | 2187.9 | 501.4 | 62.3 |
| Cl2 | kg/h | 2999.6 | 391.3 | 2608.3 | 0.0 | 0.0 | 0.0 | 2607.9 |
| Total stream | kg/h | 5000.0 | 398.5 | 4601.5 | 2689.4 | 2187.9 | 501.4 | 2685.3 |
| Temperature | ° C. | 40.0 | −7.2 | −7.2 | −39.9 | −39.9 | −39.9 | −11.4 |
| Pressure | bar | 7.9 | 7.8 | 7.8 | 7.8 | 7.8 | 7.8 | 7.8 |
| State | | gaseous | liquid | gaseous | liquid | liquid | liquid | liquid |
| Proportions | | | | | | | | |
| by mass | | | | | | | | |
| N2 | wt.-% | 3.6% | 0.0% | 3.9% | 0.0% | 0.0% | 0.0% | 0.0% |
| ARGON | wt.-% | 2.1% | 0.0% | 2.3% | 0.0% | 0.0% | 0.0% | 0.0% |
| O2 | wt.-% | 24.1% | 0.2% | 26.2% | 0.0% | 0.0% | 0.0% | 0.2% |
| CO2 | wt.-% | 3.3% | 0.3% | 3.5% | 0.0% | 0.0% | 0.0% | 0.3% |
| HCl | wt.-% | 6.9% | 1.3% | 7.4% | 100.0% | 100.0% | 100.0% | 2.3% |
| Cl2 | wt.-% | 60.0% | 98.2% | 56.7% | 0.0% | 0.0% | 0.0% | 97.1% |

| | | Stream | Stream | Stream | Stream | Stream | Stream |
|---|---|---|---|---|---|---|---|
| | | No. 8 | No. 9 | No. 10 | No. 11 | No. 12 | No. 13 |
| Mass flows | | | | | | | |
| N2 | kg/h | 0.5 | 0.0 | 181.2 | 0.5 | 181.7 | 181.7 |
| ARGON | kg/h | 0.4 | 0.0 | 104.4 | 0.4 | 104.8 | 104.8 |
| O2 | kg/h | 6.1 | 0.0 | 1199.1 | 6.1 | 1205.3 | 1205.3 |
| CO2 | kg/h | 9.9 | 0.0 | 153.2 | 9.9 | 163.1 | 163.1 |
| HCl | kg/h | 67.6 | 0.0 | 2465.9 | 569.1 | 3035.0 | 3035.0 |
| Cl2 | kg/h | 2999.2 | 2999.1 | 0.4 | 0.1 | 0.5 | 0.5 |
| Total stream | kg/h | 3083.7 | 2999.1 | 4104.2 | 586.1 | 4690.3 | 4690.3 |
| Temperature | ° C. | −10.8 | 29.8 | −54.5 | −40.5 | −52.5 | 10.0 |
| Pressure | bar | 7.8 | 8.8 | 7.8 | 7.8 | 7.8 | 7.7 |
| State | | liquid | liquid | gaseous | gaseous | gaseous | gaseous |
| Proportions by | | | | | | | |
| mass | | | | | | | |
| N2 | wt.-% | 0.0% | 0.0% | 4.4% | 0.1% | 3.9% | 3.9% |
| ARGON | wt.-% | 0.0% | 0.0% | 2.5% | 0.1% | 2.2% | 2.2% |
| O2 | wt.-% | 0.2% | 0.0% | 29.2% | 1.0% | 25.7% | 25.7% |
| CO2 | wt.-% | 0.3% | 0.0% | 3.7% | 1.7% | 3.5% | 3.5% |
| HCl | wt.-% | 2.2% | 0.0% | 60.1% | 97.1% | 64.7% | 64.7% |
| Cl2 | wt.-% | 97.3% | 100.0% | 0.0% | 0.0% | 0.0% | 0.0% |

TABLE 3a

| | | Stream | Stream | Stream | Stream | Stream |
|---|---|---|---|---|---|---|
| | | No. 1 | No. 2 | No. 3 | No. 4 | No. 5 |
| Mass flows | | | | | | |
| N2 | kg/h | 181.7 | 0.1 | 181.6 | 0.0 | 0.5 |
| ARGON | kg/h | 104.8 | 0.0 | 104.8 | 0.0 | 0.4 |
| O2 | kg/h | 1205.3 | 0.7 | 1204.6 | 0.0 | 5.8 |
| CO2 | kg/h | 163.1 | 0.9 | 162.1 | 0.0 | 10.5 |
| HCl | kg/h | 345.6 | 4.8 | 340.8 | 2489.8 | 87.4 |
| Cl2 | kg/h | 2999.6 | 358.0 | 2641.6 | 0.0 | 2984.5 |
| Total stream | kg/h | 5000.0 | 364.5 | 4635.5 | 2489.8 | 3089.2 |
| Temperature | ° C. | 40.0 | −7.0 | −7.0 | −39.9 | −10.8 |
| Pressure | bar | 7.9 | 7.8 | 7.8 | 7.8 | 7.8 |
| State | | gaseous | liquid | gaseous | liquid | liquid |
| Proportions | | | | | | |
| by mass | | | | | | |
| N2 | wt.-% | 3.6% | 0.0% | 3.9% | 0.0% | 0.0% |
| ARGON | wt.-% | 2.1% | 0.0% | 2.3% | 0.0% | 0.0% |
| O2 | wt.-% | 24.1% | 0.2% | 26.0% | 0.0% | 0.2% |
| CO2 | wt.-% | 3.3% | 0.3% | 3.5% | 0.0% | 0.3% |
| HCl | wt.-% | 6.9% | 1.3% | 7.4% | 100.0% | 2.8% |
| Cl2 | wt.-% | 60.0% | 98.2% | 57.0% | 0.0% | 96.6% |

| | | Stream | Stream | Stream | Stream | Stream |
|---|---|---|---|---|---|---|
| | | No. 6 | No. 7 | No. 8 | No. 9 | No. 10 |
| Mass flows | | | | | | |
| N2 | kg/h | 0.5 | 0.5 | 0.0 | 181.7 | 181.7 |
| ARGON | kg/h | 0.5 | 0.5 | 0.0 | 104.8 | 104.8 |
| O2 | kg/h | 6.5 | 6.5 | 0.0 | 1205.3 | 1205.3 |
| CO2 | kg/h | 11.4 | 11.4 | 0.0 | 163.1 | 163.1 |
| HCl | kg/h | 92.2 | 92.2 | 0.0 | 2835.4 | 2835.4 |
| Cl2 | kg/h | 3342.6 | 343.4 | 2999.1 | 0.4 | 0.4 |
| Total stream | kg/h | 3453.7 | 454.6 | 2999.1 | 4490.7 | 4490.7 |
| Temperature | ° C. | −10.4 | 9.2 | 29.9 | −53.2 | 10.0 |
| Pressure | bar | 7.8 | 7.8 | 8.9 | 7.8 | 7.7 |
| State | | liquid | gaseous | liquid | gaseous | gaseous |
| Proportions | | | | | | |
| by mass | | | | | | |
| N2 | wt.-% | 0.0% | 0.1% | 0.0% | 4.0% | 4.0% |
| ARGON | wt.-% | 0.0% | 0.1% | 0.0% | 2.3% | 2.3% |
| O2 | wt.-% | 0.2% | 1.4% | 0.0% | 26.8% | 26.8% |
| CO2 | wt.-% | 0.3% | 2.5% | 0.0% | 3.6% | 3.6% |
| HCl | wt.-% | 2.7% | 20.3% | 0.0% | 63.1% | 63.1% |
| Cl2 | wt.-% | 96.8% | 75.5% | 100.0% | 0.0% | 0.0% |

TABLE 3b

| | | Stream | Stream | Stream | Stream | Stream | Stream | Stream |
|---|---|---|---|---|---|---|---|---|
| | | No. 1 | No. 2 | No. 3 | No. 4 | No. 8 | No. 9 | No. 10 |
| Mass flows | | | | | | | | |
| N2 | kg/h | 181.7 | 0.1 | 181.6 | 0.0 | 0.0 | 181.7 | 181.7 |
| ARGON | kg/h | 104.8 | 0.0 | 104.8 | 0.0 | 0.0 | 104.8 | 104.8 |
| O2 | kg/h | 1205.3 | 0.7 | 1204.6 | 0.0 | 0.0 | 1205.3 | 1205.3 |
| CO2 | kg/h | 163.1 | 0.9 | 162.1 | 0.0 | 0.0 | 163.1 | 163.1 |
| HCl | kg/h | 345.6 | 4.8 | 340.8 | 2489.8 | 0.0 | 2835.4 | 2835.4 |
| Cl2 | kg/h | 2999.6 | 358.0 | 2641.6 | 0.0 | 2999.1 | 0.4 | 0.4 |
| Total stream | kg/h | 5000.0 | 364.5 | 4635.5 | 2489.8 | 2999.1 | 4490.7 | 4490.7 |
| Temperature | ° C. | 40.0 | −7.0 | −7.0 | −39.9 | 29.9 | −53.2 | 10.0 |
| Pressure | bar | 7.9 | 7.8 | 7.8 | 7.8 | 8.9 | 7.8 | 7.7 |
| State | | gaseous | liquid | gaseous | liquid | liquid | gaseous | gaseous |
| Proportions | | | | | | | | |
| by mass | | | | | | | | |
| N2 | wt.-% | 3.6% | 0.0% | 3.9% | 0.0% | 0.0% | 4.0% | 4.0% |
| ARGON | wt.-% | 2.1% | 0.0% | 2.3% | 0.0% | 0.0% | 2.3% | 2.3% |
| O2 | wt.-% | 24.1% | 0.2% | 26.0% | 0.0% | 0.0% | 26.8% | 26.8% |
| CO2 | wt.-% | 3.3% | 0.3% | 3.5% | 0.0% | 0.0% | 3.6% | 3.6% |
| HCl | wt.-% | 6.9% | 1.3% | 7.4% | 100.0% | 0.0% | 63.1% | 63.1% |
| Cl2 | wt.-% | 60.0% | 98.2% | 57.0% | 0.0% | 100.0% | 0.0% | 0.0% |

TABLE 4

| | | Stream | Stream | Stream | Stream | Stream | Stream | Stream | Stream |
|---|---|---|---|---|---|---|---|---|---|
| | | No. 1 | No. 2 | No. 3 | No. 4 | No. 5 | No. 6 | No. 7 | No. 8 |
| Mass flows | | | | | | | | | |
| N2 | kg/h | 181.7 | 0.7 | 181.0 | 0.0 | 0.0 | 0.0 | 0.0 | 0.0 |
| ARGON | kg/h | 104.8 | 0.6 | 104.2 | 0.0 | 0.0 | 0.0 | 0.0 | 0.0 |
| O2 | kg/h | 1205.3 | 8.0 | 1197.3 | 0.0 | 0.0 | 0.0 | 0.0 | 0.0 |
| CO2 | kg/h | 163.1 | 16.2 | 146.8 | 0.0 | 0.0 | 0.0 | 0.0 | 0.0 |
| HCl | kg/h | 345.6 | 75.2 | 270.4 | 3142.8 | 2014.5 | 2014.5 | 723.7 | 404.6 |
| Cl2 | kg/h | 2999.6 | 2346.0 | 653.6 | 0.0 | 0.0 | 0.0 | 0.0 | 0.0 |
| Total stream | kg/h | 5000.0 | 2446.6 | 2553.4 | 3142.8 | 2014.5 | 2014.5 | 723.7 | 404.6 |
| Temperature | ° C. | 40.0 | −32.9 | −32.9 | −30.0 | −30.0 | −51.9 | −30.0 | −30.0 |
| Pressure | bar | 8.0 | 7.8 | 7.8 | 12.0 | 12.0 | 5.0 | 12.0 | 12.0 |
| State | | gaseous | liquid | gaseous | liquid | liquid | gaseous | liquid | liquid |
| Proportions | | | | | | | | | |
| by mass | | | | | | | | | |
| N2 | wt.-% | 3.6% | 0.0% | 7.1% | 0.0% | 0.0% | 0.0% | 0.0% | 0.0% |
| ARGON | wt.-% | 2.1% | 0.0% | 4.1% | 0.0% | 0.0% | 0.0% | 0.0% | 0.0% |
| O2 | wt.-% | 24.1% | 0.3% | 46.9% | 0.0% | 0.0% | 0.0% | 0.0% | 0.0% |
| CO2 | wt.-% | 3.3% | 0.7% | 5.8% | 0.0% | 0.0% | 0.0% | 0.0% | 0.0% |
| HCl | wt.-% | 6.9% | 3.1% | 10.6% | 100.0% | 100.0% | 100.0% | 100.0% | 100.0% |
| Cl2 | wt.-% | 60.0% | 95.9% | 25.6% | 0.0% | 0.0% | 0.0% | 0.0% | 0.0% |

| | | Stream | Stream | Stream | Stream | Stream | Stream | Stream |
|---|---|---|---|---|---|---|---|---|
| | | No. 9 | No. 10 | No. 11 | No. 12 | No. 13 | No. 14 | No. 15 |
| Mass flows | | | | | | | | |
| N2 | kg/h | 0.2 | 0.9 | 180.8 | 0.0 | 0.9 | 181.7 | 181.7 |
| ARGON | kg/h | 0.2 | 0.8 | 104.1 | 0.0 | 0.8 | 104.8 | 104.8 |
| O2 | kg/h | 2.3 | 10.3 | 1194.9 | 0.0 | 10.3 | 1205.3 | 1205.3 |
| CO2 | kg/h | 5.2 | 21.5 | 141.6 | 0.0 | 21.5 | 163.1 | 163.1 |
| HCl | kg/h | 25.6 | 100.8 | 968.4 | 0.0 | 505.5 | 1473.9 | 1473.9 |
| Cl2 | kg/h | 653.4 | 2999.3 | 0.3 | 2999.3 | 0.1 | 0.3 | 0.3 |
| Total stream | kg/h | 686.9 | 3133.6 | 2590.1 | 2999.3 | 538.9 | 3129.0 | 3129.0 |
| Temperature | ° C. | −35.0 | −33.4 | −66.0 | 29.8 | −41.0 | −61.7 | 10.0 |
| Pressure | bar | 7.8 | 7.8 | 7.8 | 8.8 | 7.8 | 7.8 | 7.7 |
| State | | liquid | liquid | gaseous | liquid | gaseous | gaseous | gaseous |
| Proportions by | | | | | | | | |
| mass | | | | | | | | |
| N2 | wt.-% | 0.0% | 0.0% | 7.0% | 0.0% | 0.2% | 5.8% | 5.8% |
| ARGON | wt.-% | 0.0% | 0.0% | 4.0% | 0.0% | 0.1% | 3.3% | 3.3% |
| O2 | wt.-% | 0.3% | 0.3% | 46.1% | 0.0% | 1.9% | 38.5% | 38.5% |
| CO2 | wt.-% | 0.8% | 0.7% | 5.5% | 0.0% | 4.0% | 5.2% | 5.2% |
| HCl | wt.-% | 3.7% | 3.2% | 37.4% | 0.0% | 93.8% | 47.1% | 47.1% |
| Cl2 | wt.-% | 95.1% | 95.7% | 0.0% | 100.0% | 0.0% | 0.0% | 0.0% |

1. A process for separating chlorine from a gas stream I comprising oxygen and chlorine, wherein the gas stream I is fed into a lower part of a column K1 and a separately provided liquid, hydrogen chloride stream II is fed into an upper part of the same column and the ascending gaseous stream I is brought into contact with the descending liquid stream II, with chlorine condensing out from the stream I and hydrogen chloride vaporizing from the stream II to give an essentially chlorine-free gas stream III comprising hydrogen chloride and oxygen and a liquid stream IV comprising chlorine.

2. The process according to claim 1, wherein the liquid stream IV is fed into a lower part of a second column K2 and a further separately provided liquid hydrogen chloride stream V is fed into an upper part of the same column and an essentially chlorine-free gas stream VI comprising hydrogen chloride and oxygen and a liquid stream VII comprising essentially chlorine are obtained.

3. The process according to claim 1, wherein the stream III from the column K1 and optionally the stream VI from the column K2 are used in a heat exchanger to precool the gas stream I comprising oxygen and chlorine.

4. The process according to claim 1, wherein the liquid stream IV is fed into a second column K2 and separated into a gas stream VI comprising hydrogen chloride and oxygen and a liquid stream VII consisting essentially of chlorine and the stream VI is fed into the lower part of the column K1, with the column K2 being operated at a higher pressure than the column K1.

5. The process according to claim 1, wherein the column K1 has an enrichment section and a stripping section, with the gas stream I being fed in in the middle of the column K1 between enrichment section and stripping section and the separately provided liquid hydrogen chloride stream II is fed in at the top of the column, and the ascending gaseous stream I is brought into contact with the descending liquid stream II in the enrichment section of the column to give an essentially chlorine-free gas stream III comprising hydrogen chloride and oxygen as overhead offtake stream and a liquid stream IV consisting essentially of chlorine as bottom offtake stream.

6. The process according to claim 1, wherein the gas stream I comprising oxygen and chlorine is precooled by means of liquid hydrogen chloride in a heat exchanger.

7. The process according to claim 1, wherein the gas stream I comprising oxygen and chlorine comprises hydrogen chloride, carbon dioxide and possibly further inert gases.

8. A process for preparing chlorine from hydrogen chloride, which comprises the steps:
a) introduction of a stream a1 comprising hydrogen chloride and a stream a2 comprising oxygen into an oxidation zone and catalytic oxidation of hydrogen chloride to chlorine, giving a product gas stream a3 comprising chlorine, water, oxygen, carbon dioxide and inert gases;
b) contacting of the product gas stream a3 with aqueous hydrochloric acid in a phase contact apparatus and at least partial separation of water and of hydrogen chloride from the stream a3, leaving a gas stream b comprising hydrogen chloride, chlorine, water, oxygen, carbon dioxide and possibly inert gases;
c) drying of the gas stream b to leave an essentially water-free gas stream c comprising hydrogen chloride, chlorine, oxygen, carbon dioxide and possibly inert gases;
d) optionally compression and cooling of the gas stream c, to give a compressed or cooled or compressed and cooled gaseous stream c;
e) introduction of the optionally compressed and cooled gaseous stream c into a lower part of a column K1 and introduction of a separately provided liquid hydrogen chloride stream e into an upper part of the same column K1 and contacting of the ascending gaseous stream c with the descending liquid stream e, with gaseous chlorine condensing out from stream c and liquid hydrogen chloride vaporizing from the stream e to give an essentially chlorine-free gas stream e1 comprising hydrogen chloride, oxygen, carbon dioxide and possibly inert gases and a liquid stream e2 comprising chlorine;
f) recirculation of at least part of the gas stream e1 comprising hydrogen chloride, oxygen, carbon dioxide and possibly inert gases to the oxidation step a).

9. The process according to claim 8, wherein the liquid stream e2 is fed into a lower part of a second column K2 and a further separately provided liquid hydrogen chloride stream e3 is fed into an upper part of the same column and an essentially chlorine-free gas stream e4 comprising hydrogen chloride and a liquid stream e5 comprising essentially chlorine are obtained.

10. The process according to claim 8, wherein the stream e1 from the column K1 and optionally the stream e4 from the column K2 are used in a heat exchanger to precool the gas stream c comprising oxygen and chlorine.

11. The process according to claim 8, wherein the liquid stream e2 is fed into a second column K2 and separated into a gas stream e4 comprising hydrogen chloride and a liquid stream e5 consisting essentially of chlorine and the stream e4 is fed into the lower part of the column K1, with the column K2 being operated at a higher pressure than the column K1.

12. The process according to claim 8, wherein the gas stream c comprising oxygen and chlorine is precooled by means of liquid hydrogen chloride in a heat exchanger.

13. The process according to claim 8, wherein the stream e1 comprising hydrogen chloride and optionally the stream e4 comprising hydrogen chloride are fed to the oxidation step a) of the process.

14. The process according to claim 13, wherein a substream is separated off from the stream or streams e1 comprising hydrogen chloride and optionally e4 before introduction into the oxidation step in order to discharge inert gases.

15. The process according to claim 14, wherein the substream for discharging inert gases is subjected to scrubbing with water or aqueous hydrochloric acid to separate off hydrogen chloride.
